(19) United States
(12) Patent Application Publication
(10) Pub. No.: US 2014/0035301 A1
(43) Pub. Date: Feb. 6, 2014

(54) Strike with Ejector Plate

(71) Applicant: SOUTHERN FOLGER DETENTION EQUIPMENT COMPANY, San Antonio, TX (US)

(72) Inventor: Rene Alvarez, Seguin, TX (US)

(73) Assignee: Southern Folger Detention Equipment Company, San Antonio, TX (US)

(21) Appl. No.: 13/933,210

(22) Filed: Jul. 2, 2013

Related U.S. Application Data
(60) Provisional application No. 61/677,574, filed on Jul. 31, 2012.

(51) Int. Cl. E05B 15/02

(52) U.S. Cl. CPC E05B 15/02
USPC 292/341.14

(57) ABSTRACT

A lock with a latch and a strike having an ejector plate slidably mounted within the strike box of the strike. The ejector plate is spring-loaded in order to eject foreign material from the strike box to assure that the strike box is cleared to accept the latch bolt of the latch.

### CROSS REFERENCE TO RELATED PATENT APPLICATIONS

This invention claims priority from U.S. Provisional Patent Application No. 61/677,574, filed Jul. 31, 2012, which is hereby incorporated by reference.

### FIELD OF THE INVENTION

This invention relates to a strike for an electromechanical lock used on a prison cell door, and more particularly to a strike that precludes foreign material from being stuffed into the strike to defeat the lock.

### BACKGROUND OF THE INVENTION

A door for a prison cell has a lock, which typically includes an electromechanical latch with a latch bolt positioned in the door jamb and a corresponding strike positioned on the cell door. The conventional strike includes a strike faceplate for attaching the strike to the door and a strike box with a strike opening for accommodating the latch bolt. In order to defeat a conventional lock on a prison cell door, prison inmates on occasion stuff foreign material through the strike opening into the strike box so that when the cell door closes, the latch bolt cannot fully engage the strike opening thereby leaving the cell door unsecured.

### SUMMARY OF THE INVENTION

In order to overcome the problem presented by prison inmates stuffing foreign material into the strike box of the strike, the strike of the present invention includes a spring-loaded ejector plate slidably mounted within the strike box for ejecting foreign materials from the strike box while at the same time giving the prison guard a visual indication that the strike box is clear of foreign materials. The ejector plate includes cylindrical rods that engage holes in the end wall of the strike box so that the ejector plate can slide fore and aft in the strike box. The ejector plate is spring-loaded by springs that urge the ejector plate within the strike box toward the strike opening. When the electromechanical latch is closed, the latch bolt of the electromechanical latch forces the ejector plate into the strike box against the force of the springs of the ejector plate. When the electromechanical latch is opened and the latch bolt is withdrawn, the springs push the ejector plate toward the strike opening. Consequently, an attempt to stuff foreign material into the exposed strike box is foiled by the spring-loaded ejector plate ejecting the foreign material from the strike box.

In addition, the front face of the ejector plate is painted a bright color, such as green, so that a prison guard can tell at a glance whether the ejector plate is extended and the strike box is clear. Further, the inside of the strike box may be coated with a slippery material, such as a Teflon brand coating, making it difficult for foreign materials to be retained in the strike box against the spring force of the ejector plate.

Further objects, features and advantages will become apparent upon consideration of the following detailed description of the invention when taken in conjunction with the drawings and the appended claims.

### BRIEF DESCRIPTION OF THE DRAWINGS

FIG. 1 is left front perspective view of a lock including a latch and a strike in accordance with the present invention.

FIG. 2 is a right front perspective view of the lock in accordance with the present invention.

FIG. 3 is an enlarged front perspective of the strike for the lock in accordance with the present invention.

FIG. 4 is an exploded, back perspective view of the strike in accordance with the present invention.

FIG. 5 is a side elevation view of the strike in accordance with the present invention.

FIG. 6 is a front elevation view of the strike in accordance with the present invention.

FIG. 7 is a top plan view of the strike in accordance with the present invention.

FIG. 8 is a front elevation view of an ejector plate in accordance with the present invention.

FIG. 9 is a side elevation view of the ejector plate in accordance with the present invention.

### DETAILED DESCRIPTION OF THE PREFERRED EMBODIMENT

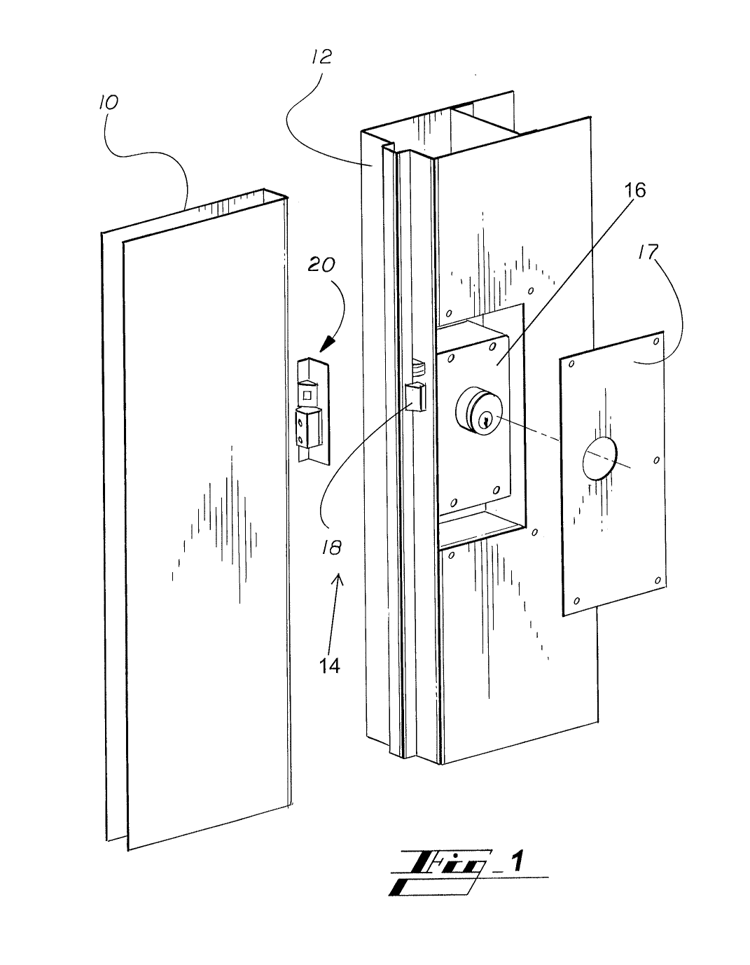

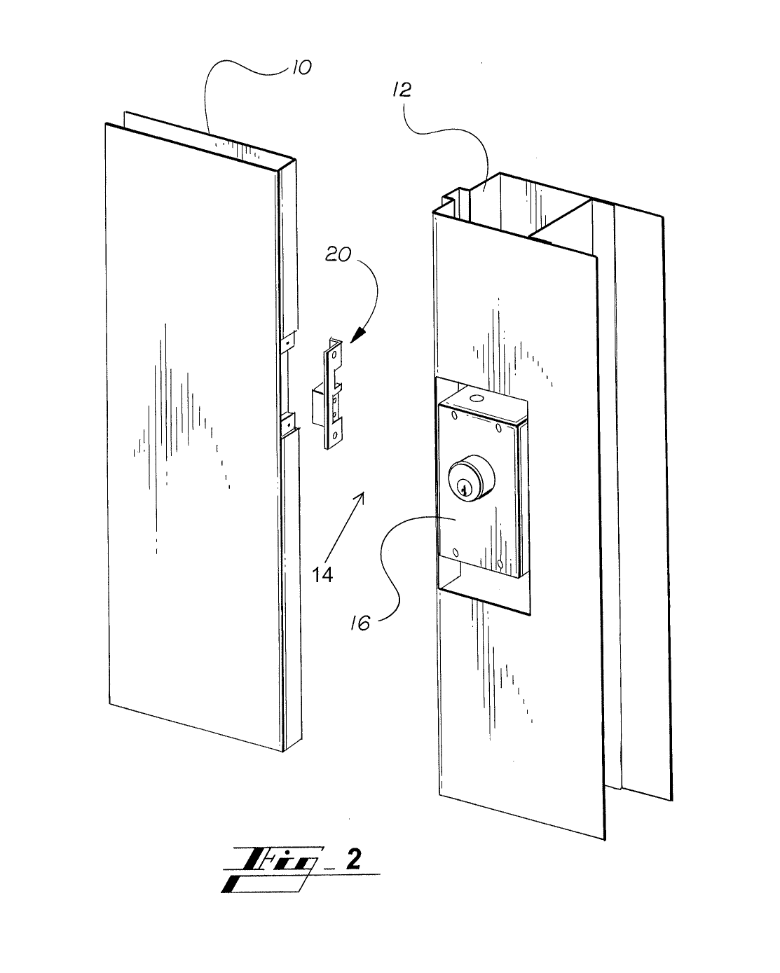

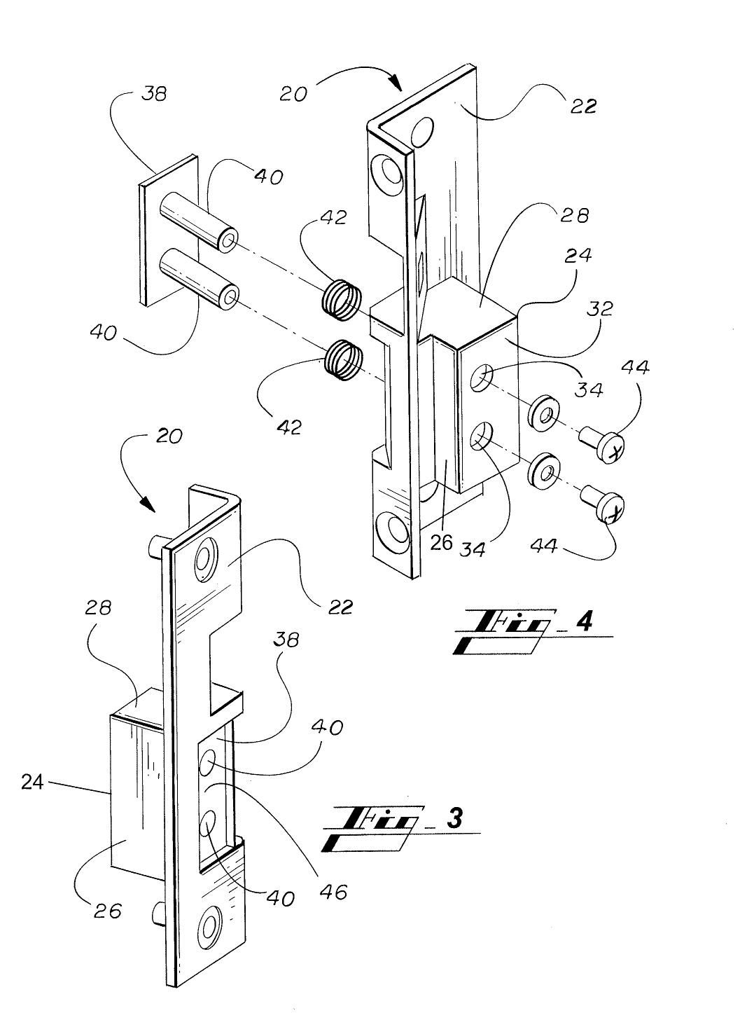

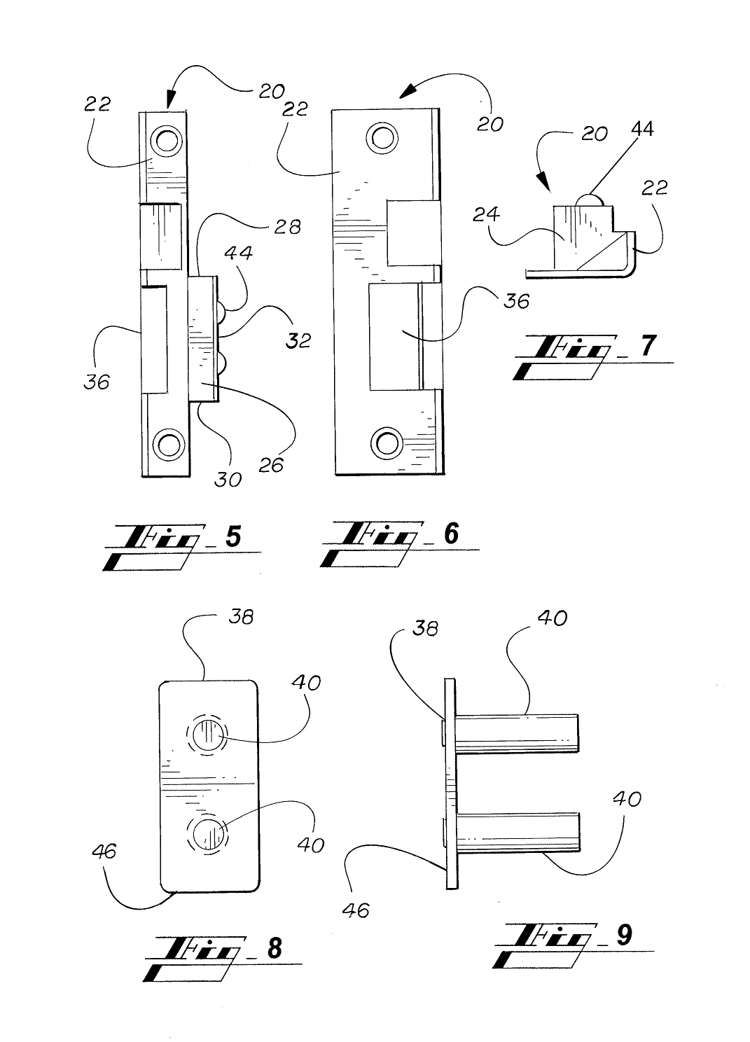

FIGS. 1 and 2 show a lock 14 including an electromechanical latch 16 mounted in a door jamb 12 and a strike 20 mounted on a cell door 10. The strike 20 on the cell door 10 is aligned with the electromechanical latch 16 so that a latch bolt 18 of the latch 16 can engage a strike opening 36 of the strike 20 in order to secure the cell door 10 to the door jamb 12. FIGS. 3-7 show the strike 20 in greater detail. FIGS. 8 and 9 show the details of an ejector plate 38 for the strike 20. While the latch 16 is shown mounted in the door jamb 12 and the strike 20 is shown mounted on the cell door 10, the relative positioning could be reversed with the latch 16 mounted on the cell door 10 and the strike 20 mounted on the door jamb 12.

The electromechanical latch 16 includes the latch bolt 18 which, in conventional fashion, extends to engage the opening 36 of the strike 20 in order to hold the cell door closed, and retracts from the strike 20 in order to allow the cell door to open. The latch bolt 18 may be spring biased toward the extended position or may be mechanically driven by the electromechanical mechanism toward the extended position.

With reference to FIGS. 3-9, the strike 20 includes an L-shaped faceplate 22 for mounting the strike 22 on the cell door 10. The strike 20 also includes a strike box 24 having side walls 26, a top wall 28, a bottom wall 30, an end wall 32, and the strike opening 36. The end wall 32 includes holes 34 (FIG. 4).

With reference to FIGS. 4, 8, and 9, the ejector plate 38 has a front face 46 (FIG. 8) and is slidably mounted in the strike box 24. The ejector plate 38 has two parallel extending rods 40 that engage the holes 34 in the end wall 32 of the strike box 24. Compression springs 42 are mounted on the rods 40 between the ejector plate 38 and the end wall 32 of the strike box 24. The compression springs 42 urge the ejector plate 38 toward the strike opening 36. The rods 40 are restrained from disengaging the holes 34 by screws 44 which are threaded into the rods 40.

The ejector plate 38 and the strike box 24 are dimensioned so that the ejector plate 38 fits within the strike box 24 with minimum sliding clearance between the edges of the ejector plate 38 and the side walls 26, the top wall 28, and the bottom wall 30 of the strike box 24. Other mechanisms for mounting the ejector plate 38 within the strike box 24 may be employed to allow the ejector plate 38 to slide fore and aft within the strike box 24.

The front face 46 of the ejector plate 38 is brightly colored. In addition, the internal surfaces of the side walls 26, the top wall 28, and the bottom wall 30 are low friction surfaces, such as Teflon brand coated surfaces.

In operation, the ejector plate 38 operates to thwart inmates from stuffing foreign material into the strike box 24 when the strike 20 is exposed and thus defeat the lock 14. When the electromechanical latch 16 is closed, the latch bolt 18 of the electromechanical latch 16 forces the ejector plate 38 into the strike box 24 against the combined force of the springs 42. Consequently, the extending force of the latch bolt 18 must be sufficient to overcome the combined force of springs 42. When the electromechanical latch 16 is opened and the latch bolt 18 is withdrawn, the combined force of the springs 42 push the ejector plate 38 toward the strike opening 36. While the strike opening 36 is exposed, an attempt to stuff foreign material into the strike box 24 will be unsuccessful because the combined force of springs 42 on the ejector plate 38 will eject foreign materials from the strike box 24. In addition, because the internal surfaces of the side walls 26, the top wall 28, and the bottom wall 30 are low friction, the ability of the ejector plate 38 eject foreign materials from the strike box 24 is enhanced.

In addition, because the outside face 46 of the ejector plate 38 is painted a bright color, such as green, a prison guard can tell at a glance whether the ejector plate 38 is extended and the strike box 24 is clear.

While this invention has been described with reference to preferred embodiments thereof, it is to be understood that variations and modifications can be affected within the spirit and scope of the invention as described herein and as described in the appended claims.

I claim:

1. A lock comprising:
a. a latch with a latch bolt for mounting on a door or a jamb; and
b. a strike mounted on a facing jam or door and aligned with the latch, the strike comprising:
i. an enclosed strike box having internal surfaces and an opening, and
ii. an ejector plate slidably mounted in the strike box and urged toward the opening.

2. The lock of claim 1, wherein the ejector plate has a face exposed to the opening, and the face is painted a bright color.

3. The lock of claim 1, wherein one or more of the internal surfaces of the strike box are coated with a low friction coating.
